(19) United States
(12) Patent Application Publication
(10) Pub. No.: US 2010/0251029 A1
(43) Pub. Date: Sep. 30, 2010

(54) IMPLEMENTING SELF-OPTIMIZING IPL DIAGNOSTIC MODE

(75) Inventors: Salim Ahmed Agha, Rochester, MN (US); Steven C. Erickson, Rochester, MN (US); Fraser Allan Syme, Rochester, MN (US)

Correspondence Address: IBM CORPORATION;ROCHESTER IP LAW DEPT 917, 3605 HIGHWAY 52 N, ROCHESTER, MN, 55901-7829, US

(73) Assignee: INTERNATIONAL BUSINESS MACHINES CORPORATION, Armonk, NY (US)

(21) Appl. No.: 12/411,645

(22) Filed: Mar. 26, 2009

(51) Int. Cl. G06F 11/22

(52) U.S. Cl. 714/40; 714/E11.148

(57) ABSTRACT

A method, apparatus and computer program product are provided for implementing self-optimizing initial program load (IPL) diagnostics. A control flag is set to identify a self-optimizing IPL diagnostics mode. The self-optimizing IPL diagnostics mode includes collecting a list of new parts and collecting a list of identified failed parts. Hardware is identified and initialized for running diagnostics on the collected list of flagged parts. Diagnostics are run only on the initialized flagged hardware.

### FIELD OF THE INVENTION

The present invention relates generally to the data processing field, and more particularly, relates to a method, apparatus and computer program product for implementing self-optimizing initial program load (IPL) diagnostic mode.

### DESCRIPTION OF THE RELATED ART

When a complex electronic product is powered on, typically a service processor or a microcontroller starts a suite of diagnostics tests that are used to determine if the underlying hardware is in a good enough shape to be the foundation for software operating systems and applications.

When these tests fail, parts or field replaceable units (FRUs) are called out as defective by the IPL diagnostic routines. When a repair representative is called, the repair representative looks at service processor logs or diagnostic error codes to determine which parts are suspected as being defective.

After a replacement part/component is installed or reseated, it takes a complete additional IPL and running all IPL diagnostics of the system to determine if the original problem has been resolved. In some large systems, that may take, for example, between 20 minutes to 2 hours depending on the system configuration.

Time spent waiting for all the other aspects of the system to complete IPL diagnostics is basically wasted time. In the field, customer downtime should be kept minimal.

Electronic system configurations are getting more complex, and more diagnostics and repair actions often are required. A need exists to provide manufacturing and service personnel with a capability to quickly diagnose if the repair action fixed the intended problem quickly so that system downtime is minimized.

### SUMMARY OF THE INVENTION

Principal aspects of the present invention are to provide a method, apparatus and computer program product for implementing a self-optimizing initial program load (IPL) diagnostic mode. Other important aspects of the present invention are to provide such method, apparatus and computer program product substantially without negative effect and that overcome many of the disadvantages of prior art arrangements.

In brief, a method, apparatus and computer program product are provided for implementing self-optimizing initial program load (IPL) diagnostics. A control flag is set to identify a self-optimizing IPL diagnostics mode. The self-optimizing IPL diagnostics mode includes collecting a list of new parts and collecting a list of identified failed parts. Hardware is identified and initialized for running diagnostics on the collected list of flagged parts. Diagnostics are run only on the initialized flagged hardware.

In accordance with features of the invention, the collected list of flagged parts are field replaceable units (FRUs) and the required hardware identified and initialized for running diagnostics is dynamically determined for the identified FRUs.

In accordance with features of the invention, a configuration map of existing system configuration is maintained at least to the level of hardware part FRU based on Vital Product Data (VPD).

In accordance with features of the invention, an error log stores new and failed hardware parts or FRUs. Manufacturing and service users set the control flag to quickly diagnose if a repair action fixed the intended problem.

In accordance with features of the invention, in a system with multiple independent nodes, a master service processor of one independent node communicates with the user and with each service processor of other independent nodes.

### BRIEF DESCRIPTION OF THE DRAWINGS

The present invention together with the above and other objects and advantages may best be understood from the following detailed description of the preferred embodiments of the invention illustrated in the drawings, wherein:

FIGS. 1A and 1B are a block diagram representations illustrating a system for implementing self-optimizing initial program load (IPL) diagnostics in accordance with the preferred embodiment;

FIGS. 2A and 2B together provide a flow chart illustrating exemplary steps for implementing self-optimizing initial program load (IPL) diagnostics in accordance with the preferred embodiment; and

FIG. 3 is a block diagram illustrating a computer program product in accordance with the preferred embodiment.

### DETAILED DESCRIPTION OF THE PREFERRED EMBODIMENTS

In accordance with features of the invention, a method is provided for implementing self-optimizing initial program load (IPL) diagnostics. A self-optimizing IPL diagnostics mode is provided enabling optimized IPL diagnostics to only consider the parts that are either new or were previously marked as bad. A single flag/bit is set to identify the self-optimizing IPL diagnostics mode.

In accordance with features of the invention, valuable time for debugging of hardware failures is saved. In general shorter debug cycle times in manufacturing are enabled. Reduced allocated time of test fixtures is enabled and improved system test capacity and throughput is enabled. Customer down time for repair and upgrades in the field advantageously is minimized.

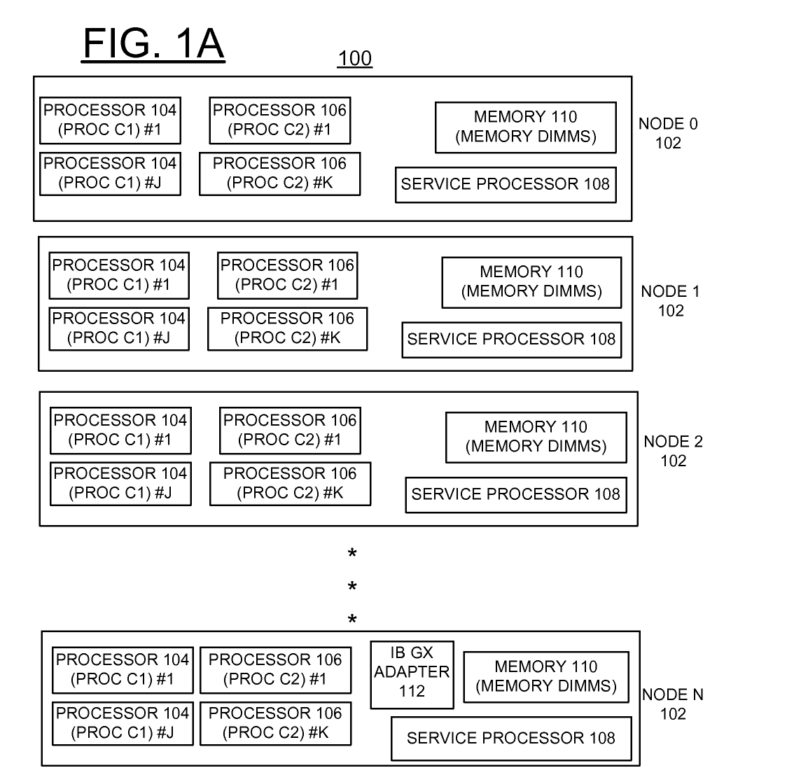

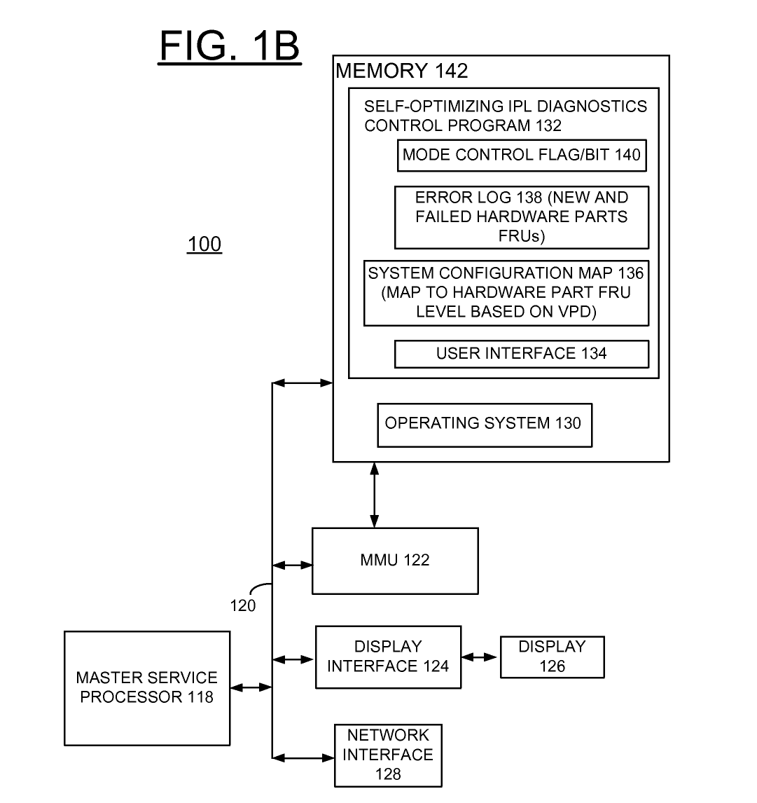

Having reference now to the drawings, in FIGS. 1A and 1B, there is shown a computer system for implementing self-optimizing initial program load (IPL) diagnostics generally designated by the reference character 100 in accordance with the preferred embodiment. Computer system 100 includes a plurality of nodes 0-N, 102, for example, of a multiple node server. As shown, nodes 0-N, 102 include a plurality of processors 104, processor C1, #1-J, a plurality of processors 106, processor C2, #1-K, a service processor 108, and a memory 110, such as a plurality of memory dual in-line memory modules (DIMMs). Node 1002, N includes an InfiniBand adapter 112, such as an IB GX adapter, as shown.

As shown in FIG. 1B, computer system 100 includes a master service processor 118 coupled to a system bus 120 to a memory management unit (MMU) 122. Service processor 108 of a master node, such as Node 0, 102, implements the master service processor 118, for example. Computer system 100 optionally includes multiple independent nodes 0-N, 102, each having a separate service processor 108.

In accordance with features of the invention, an end user interacts with a master service processor only such as of Node 0, 102, and the master service processor 108 threads the diagnostic activities to the children service processor in each node 1-N, 102. Each of the children service processors in each node 1-N, 102 runs diagnostics and the results and monitoring is fed back to the master service processor 108 of Node 0, 102.

Computer system 100 includes a display interface 124 connected to a display 126, and a network interface 128 coupled by the system bus 120 to the master service processor 118.

Computer system 100 includes an operating system 130, a self-optimizing IPL diagnostics control program 132 of the preferred embodiment, and a user interface 134.

In accordance with features of the invention, computer system 100 includes a system configuration map 136 of existing system configuration at least to the level of hardware part or FRU based on the electronic Vital Product Data (VPD), an error log 138 of new and failed hardware parts or FRUs, and a mode control flag or bit 140 of the preferred embodiment, stored in a memory 142.

Computer system 100 includes a memory management unit (MMU) 122 coupled to the memory 142 and coupled by the system bus 120 to the master service processor 118.

Computer test system 100 is shown in simplified form sufficient for understanding the present invention. The illustrated computer test system 100 is not intended to imply architectural or functional limitations. The present invention can be used with various hardware implementations and systems and various other internal hardware devices.

In accordance with features of the invention, service Processor 118 stores the map 136 of the existing configuration of system 100 to the level of the hardware part or FRU based on the electronic Vital Product Data (VPD). As the various IPL diagnostic steps are completed, any failures are logged such that the likely defective part, FRU, module, chip or even net is identified by the failing diagnostic routine and logging of errors to the error log 138, and also activating of indicator lights, display of error codes, and the like.

In accordance with features of the invention, IPL diagnostics are optimized for performing diagnostic steps for the parts of FRUs that are either identified new or were previously marked as bad. This functionality is enabled by setting the single flag/bit 140 to identify the self-optimizing IPL diagnostics mode.

For example, consider computer system 100 having an identified failed processor 106, C2 in node 0, 102, an identified failed quad of memory DIMMs 110 on processor 104, C1 in node 1, 102, and an identified failed IB adapter 112 in node N, 102.

In the conventional diagnostics after the FRUs are replaced, a complete diagnostics run for the entire configuration of computer system would be performed.

In accordance with features of the invention, self-optimizing IPL diagnostics are performed, for example, with the technician triggering the self-optimizing IPL diagnostic mode through the service processor 118. Self-optimizing IPL diagnostics are optimized for performing diagnostic steps with the service processor 118 checking if this mode is enabled, and if so, polls the persistent data for all resources deemed new or flagged as requiring diagnostics. For example, the deemed new resources and resources flagged as requiring diagnostics are identified by checking Vital Product Data (VPD) attributes. Then the minimum hardware required in each node to functionally run diagnostics for the marked parts or FRUs is identified or calculated. For example, the identified failed processor 106, C2 and a quad of memory DIMMs 110 in the processor C2 in node 0, 102; processor 104, C1, processor 106, C2 and identified failed quad of memory DIMMs 110 on processor 104, C1 in node 2, 102, and the identified failed IB adapter 112 in node N, 102. This hardware is initialized to make the system IPL.

Then if there was a failure for a poorly seated DIMM in node 2, 102, the service processor would again mark the part or FRU in persistent data and would again mark the actual IPL diagnostic routine in which the failure occurred, for example, a particular diagnostics step.

Next after the technician re-enables the verify mode or self-optimizing IPL diagnostic mode after reseating the poorly seated DIMM in node 2, 102, then this VPD for this part or FRU will be the same in persistent data because the part was not changed. The IPL diagnostics code reinitializes and recalculates the minimum hardware required to support diagnostics in node 2, 102. For example, only processor 104, C1 and the one quad of memory DIMMs in node 2, 102 are required to support diagnostics in node 2, 102 on this memory DIMM 2.

Once this test completes, the system does not complete the IPL. The service processor again marks the persistent VPD data for this memory quad of DIMMs as complete up through the diagnostics performed, and when no diagnostics failures are indicated against all four memory DIMMs and the processor 104, C1, the service processor communicates the result of PASS to the technician using for example, the display 126, console, LED, or the like. As a result, the time required for such diagnostics is significantly reduced in accordance with features of the invention as compared to conventional diagnostics of the entire system 100.

In accordance with features of the invention, when a diagnostic IPL completes successfully, the previous problems stored in the persistent storage error log 138 are cleared. Otherwise, when the self-optimizing IPL diagnostics mode is initiated by the operator and the mode control flag or bit 140 is set, the service processor 118 consults the persistent storage 138 and only schedules IPL diagnostics as required because new hardware is detected and needs to be verified and/or previously-failed hardware is still present and has not been successfully verified. In the case where detailed information is available to identify part, module, chip or net, the diagnostic code itself optimizes itself around verifying the previously detected problem, and any function that had been aborted during the previous failure. The self-optimizing IPL diagnostics mode limits diagnostics to the smallest possible hardware coverage based on the architectural limitations of the product.

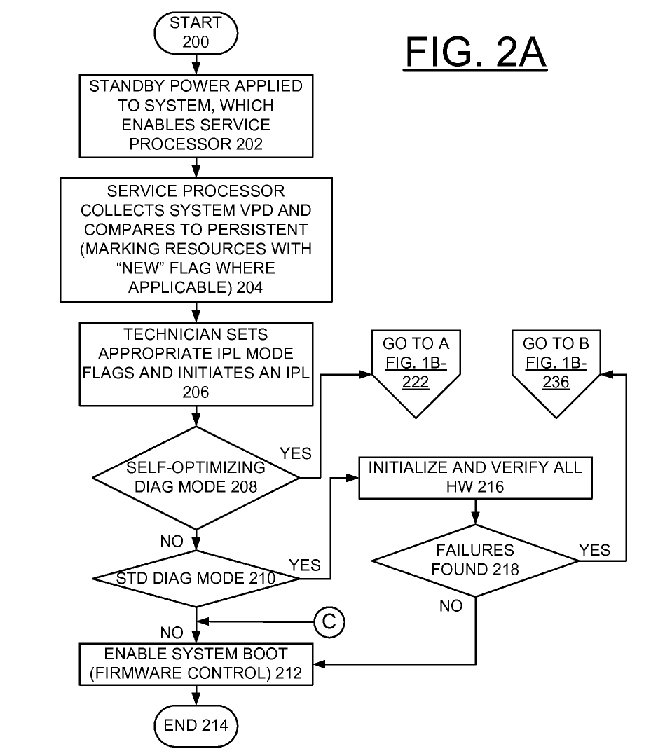

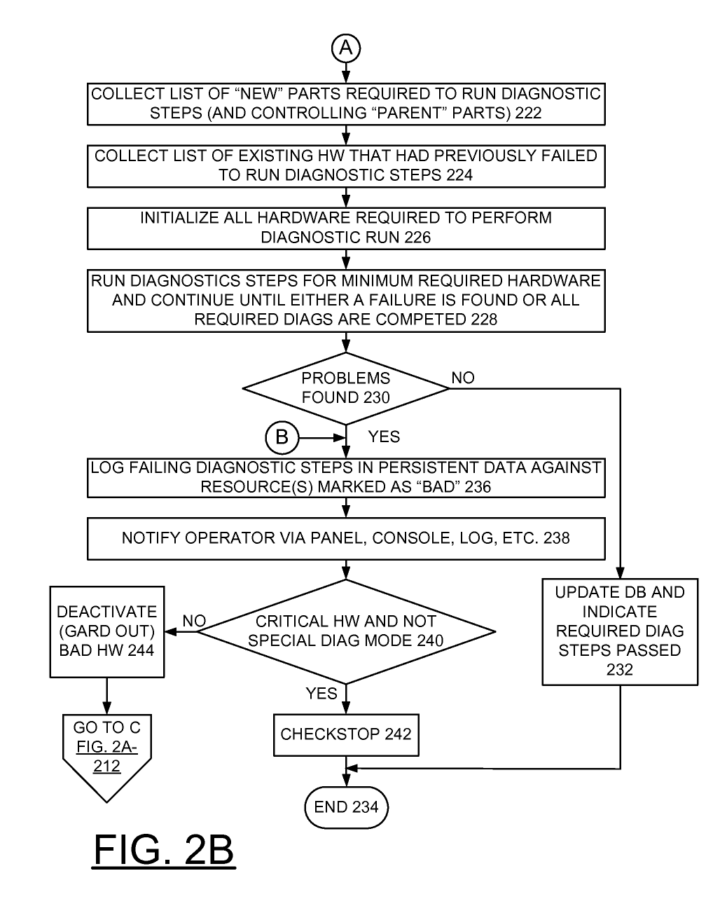

Referring now to FIGS. 2A and 2B, there are shown exemplary steps for implementing self-optimizing initial program load (IPL) diagnostics in accordance with the preferred embodiment starting at a block 200. As indicated at a block 202, standby power is applied to the system, which enables service processor. The service processor collects system Vital Product Data (VPD), and compares the system VPD to stored persistent data, which marks resources with a new flag where applicable as indicated at a block 204.

A technician sets appropriate IPL mode flag or flags where appropriate and initiates an IPL as indicated at a block 206. Checking for the self-optimizing IPL diagnostics mode is performed as indicated at a decision block 208. When the self-optimizing IPL diagnostics mode is not selected, then checking for the standard diagnostics mode is performed as indicated at a decision block 210. When the standard diagnostics mode is not selected, then system boot firmware control is enabled as indicated at a block 212. Sequential operations end as indicated at a block 214.

When standard diagnostics mode is selected, then all system hardware is initialized and verified as indicated at a block 216. Checking whether any failures have been found is performed as indicated at a decision block 218. When no failures have been found, then the system boot firmware control is enabled at block 212. Sequential operations end at block 214.

Otherwise when the self-optimizing IPL diagnostics mode is identified at decision block 208, then operations continue at block 222 in FIG. 1B following entry point A. When failures have been found at decision block 218, then operations continue at block 236 in FIG. 1B following entry point B.

In FIG. 1B, a list of new parts to run diagnostic steps including controlling parent parts is collected as indicated at a block 222. Next a list of existing hardware that had previously failed to run diagnostic steps is collected as indicated at a block 224. Then all hardware required to perform diagnostic run is initialized as indicated at a block 226. Diagnostic steps are run for minimum required hardware and continues until either a failure is found or all required diagnostics are completed as indicated at a block 228. Checking whether any problems have been found is performed as indicated at a decision block 230. When no problems have been found, then persistent storage database (DB) is updated, indicating that required diagnostic steps have passed as indicated at a block 232. Sequential operations end as indicated at a block 234.

When any problems have been found at decision block 230 and when failures are found at decision block 218 in FIG. 1A, then failing diagnostic steps are logged in persistent data against the resource or resources marked as bad as indicated at a block 236. The technician or operator is notified vial panel display, console, log, and the like as indicated at a block 238.

Checking for critical hardware having problems or failed, and not special diagnostics mode is performed as indicated at a decision block 240. If critical hardware having problems or failed, and not special diagnostics mode are identified, the operations checkstop as indicated at a block 242 with normal operation not possible. Then sequential operations end at block 234.

Otherwise, critical hardware having problems or failed, and not special diagnostics mode is not identified, then the hardware is deactivated and identified as bad hardware as indicated at a block 244. Then operations continue following entry point C in FIG. 1A, system boot firmware control is enabled at block 212. Then sequential operations end at block 214.

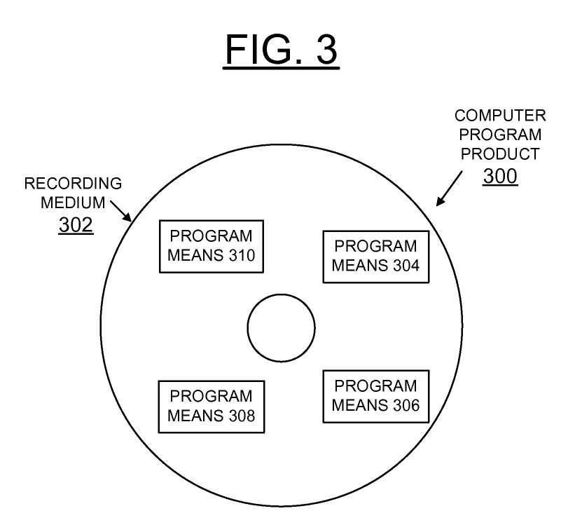

Referring now to FIG. 3, an article of manufacture or a computer program product 300 of the invention is illustrated. The computer program product 300 includes a recording medium 302, such as, a floppy disk, a high capacity read only memory in the form of an optically read compact disk or CD-ROM, a tape, or another similar computer program product. Recording medium 302 stores program means 304, 306, 308, 310 on the medium 302 for carrying out the methods for implementing self-optimizing initial program load (IPL) diagnostics of the preferred embodiment in the system 100 of FIGS. 1A and 1B.

A sequence of program instructions or a logical assembly of one or more interrelated modules defined by the recorded program means 304, 306, 308, 310, direct the computer system 100 for implementing a self-optimizing initial program load (IPL) diagnostic mode of the preferred embodiment.

Embodiments of the present invention may also be delivered as part of a service engagement with a client corporation, nonprofit organization, government entity, internal organizational structure, or the like. Aspects of these embodiments may include configuring a computer system to perform, and deploying software, hardware, and web services that implement, some or all of the methods described herein. Aspects of these embodiments may also include analyzing the client's operations, creating recommendations responsive to the analysis, building systems that implement portions of the recommendations, integrating the systems into existing processes and infrastructure, metering use of the systems, allocating expenses to users of the systems, and billing for use of the systems.

While the present invention has been described with reference to the details of the embodiments of the invention shown in the drawing, these details are not intended to limit the scope of the invention as claimed in the appended claims.

What is claimed is:

1. A computer-implemented method for implementing self-optimizing initial program load (IPL) diagnostics in a computer system comprises:
providing a control flag to identify a self-optimizing IPL diagnostics mode;
responsive to identifying said self-optimizing IPL diagnostics mode, collecting a list of new parts and collecting a list of identified failed parts;
identifying and initializing hardware for running diagnostics on the collected list of flagged parts; and
running diagnostics only on the initialized flagged hardware.

2. The computer-implemented method as recited in claim 1 wherein collecting a list of new parts includes identifying at least one new field replaceable unit (FRU).

3. The computer-implemented method as recited in claim 2 wherein collecting a list of identified failed parts includes identifying at least one failed field replaceable unit (FRU).

4. The computer-implemented method as recited in claim 1 includes storing a system configuration map, said system configuration map being provided at least to a level of a field replaceable unit (FRU) and based on Vital Product Data (VPD).

5. The computer-implemented method as recited in claim 1 wherein each new part includes a field replaceable unit (FRU), and wherein providing said control flag to identify said self-optimizing IPL diagnostics mode includes collecting system Vital Product Data (VPD) and marking a new FRU.

6. The computer-implemented method as recited in claim 5 wherein a user sets said control flag to identify said self-optimizing IPL diagnostics mode responsive to the marked new FRU.

7. The computer-implemented method as recited in claim 1 wherein the computer system includes multiple independent nodes, a master service processor of one independent node communicates with a user and each service processor of other independent nodes.

8. The computer-implemented method as recited in claim 1 wherein each flagged part includes at least one field replaceable unit (FRU) and wherein identifying and initializing hardware for running diagnostics on the collected list of flagged parts includes dynamically determining hardware for running diagnostics for each identified FRU.

9. The computer-implemented method as recited in claim 1 wherein a service user sets the control flag to determine if a repair action was successful.

10. The computer-implemented method as recited in claim 1 wherein each flagged part includes at least one field replaceable unit (FRU) and wherein running diagnostics only on the initialized flagged hardware includes logging a failure to indicate a defective FRU.

11. The computer-implemented method as recited in claim 1 wherein each flagged part includes at least one field replaceable unit (FRU) and wherein running diagnostics only on the initialized flagged hardware includes clearing the list of identified failed parts, responsive to successfully completing diagnostics.

12. A computer program product embodied on a computer readable storage medium for implementing self-optimizing initial program load (IPL) diagnostics in a computer system, said computer readable storage medium storing instructions, and said instructions when executed by the computer system cause the computer system to perform the steps comprising:
providing a control flag to identify a self-optimizing IPL diagnostics mode;
responsive to identifying said self-optimizing IPL diagnostics mode, collecting a list of new parts and collecting a list of identified failed parts;
identifying and initializing hardware for running diagnostics on the collected list of flagged parts; and
running diagnostics only on the initialized flagged hardware.

13. The computer program product as recited in claim 12 further comprises storing a system configuration map, said system configuration map being provided at least to a level of a field replaceable unit (FRU) and based on Vital Product Data (VPD).

14. The computer program product as recited in claim 12 wherein each new part includes a field replaceable unit (FRU), and wherein providing said control flag to identify said self-optimizing IPL diagnostics mode includes collecting system Vital Product Data (VPD) and marking a new FRU.

15. The computer program product as recited in claim 14 wherein a user sets said control flag to identify said self-optimizing IPL diagnostics mode responsive to the marked new FRU.

16. The computer program product as recited in claim 12 wherein each flagged part includes a field replaceable unit (FRU) and wherein identifying and initializing required hardware for running diagnostics on the collected list of flagged parts includes dynamically determining hardware for running diagnostics for each identified FRU.

17. The computer program product as recited in claim 12 wherein each flagged part includes at least one field replaceable unit (FRU) and wherein running diagnostics only on the initialized flagged hardware includes logging of a failure to indicate a defective FRU.

18. An apparatus for implementing self-optimizing initial program load (IPL) diagnostics in a computer system comprises:
a service processor identifying a control flag for a self-optimizing IPL diagnostics mode;
said service processor responsive to identifying said self-optimizing IPL diagnostics mode, collecting a list of new parts and collecting a list of identified failed parts;
said service processor identifying and initializing hardware for running diagnostics on the collected list of flagged parts; and
said service processor running diagnostics only on the initialized required hardware.

19. The apparatus for implementing self-optimizing initial program load (IPL) diagnostics as recited in claim 18 further comprises memory storing a system configuration map, said system configuration map being provided at least to a level of a field replaceable unit (FRU) and based on Vital Product Data (VPD) and wherein said service processor providing said control flag to identify said self-optimizing IPL diagnostics mode includes said service processor collecting system Vital Product Data (VPD) and marking a new FRU.

20. The apparatus for implementing self-optimizing initial program load (IPL) diagnostics as recited in claim 18 wherein the computer system includes multiple independent nodes, and wherein said service processor includes a master service processor of one independent node, said master service processor communicates with a user and each service processor of other independent nodes.
